(19) United States
(12) Patent Application Publication
(10) Pub. No.: US 2025/0033566 A1
(43) Pub. Date: Jan. 30, 2025

(54) Vehicle-Attachable Work Platform Device

(71) Applicant: Jay Driggers, Florence, SC (US)

(72) Inventor: Jay Driggers, Florence, SC (US)

(21) Appl. No.: 18/422,300

(22) Filed: Jan. 25, 2024

Related U.S. Application Data
(60) Provisional application No. 63/516,078, filed on Jul. 27, 2023.

(51) Int. Cl. B60R 3/00

(52) U.S. Cl. CPC B60R 3/007

(57) ABSTRACT

A vehicle-attachable work platform device is provided. The device is comprised of a body which is further comprised of a first platform half and a second platform half that may fold together via at least one hinge. Attached to each platform half is at least one arm which is comprised of a fastener that attaches the device to the front end of a vehicle, such as a truck, to perform work on the engine bay of the vehicle. Each platform half is further comprised of a leg that may be telescoping to provide additional support and accommodate different-sized vehicles and uneven ground surfaces.

### CROSS-REFERENCE TO RELATED APPLICATION

The present application claims priority to, and the benefit of, U.S. Provisional Application No. 63/516,078, which was filed on Jul. 27, 2023, and is incorporated herein by reference in its entirety.

### FIELD OF THE INVENTION

The present invention relates generally to the field of working platforms. More specifically, the present invention relates to a vehicle-attachable work platform device that attaches the device to the front end of a vehicle, such as, but not limited to, a truck, to allow a user to stand on the device and perform work on the engine bay of the vehicle. Accordingly, the present disclosure makes specific reference thereto. Nonetheless, it is to be appreciated that aspects of the present invention are also equally applicable to other like applications, devices, and methods of manufacture.

### BACKGROUND

Performing maintenance or repair tasks on the engine of a truck (or other tall vehicle) presents a unique set of challenges, primarily due to the elevated position of the front end. Typically, the front of the truck is raised to a considerable height, rendering it practically inaccessible without the aid of a ladder or some form of platform that elevates you to a safe working height. This height differential can complicate even the simplest of repair or maintenance tasks, turning what might seem like routine work into a challenging endeavor.

When attempting to access the engine compartment of a truck, makeshift solutions like using a chair or an unstable ladder not only make the task more complicated but also introduce a significant element of danger into the equation. The risks associated with such practices are amplified when working alone, as there is no immediate assistance available in case of an accident or mishap. As a result, slips and falls become all too common in these situations. Such accidents can result in serious injuries, ranging from minor bruises to more severe consequences like fractures or head injuries. Moreover, the potential damage to the truck itself is another concern.

Therefore, there exists a long-felt need in the art for a device that provides an increase in elevation when performing work on the front end of a truck or other raised vehicle. More specifically, there exists a long-felt need in the art for a vehicle-attachable work platform device that attaches to the front end of a truck and provides a stable surface from which a mechanic may perform work. Furthermore, there exists a long-felt need in the art for a vehicle-attachable work platform device that can be easily stored and transported.

The subject matter disclosed and claimed herein, in one embodiment thereof, comprises a vehicle-attachable work platform device. The device is comprised of a body which is further comprised of a first platform half and a second platform half that may fold together via at least one hinge. Attached to each platform half is at least one arm which is further comprised of a fastener that attaches the device to the front end of a vehicle, such as a truck, which secures the device to the truck to allow the user to stand on the device and perform work on the engine bay of the vehicle. Each platform half is further comprised of a leg that may be telescoping to provide additional support and accommodate different-sized vehicles and uneven ground surfaces.

In this manner, the vehicle-attachable work platform device of the present invention accomplishes all the foregoing objectives and provides a device that allows a user to easily access the front end of a truck or other raised vehicle to perform work on the vehicle. More specifically, the vehicle-attachable work platform device attaches to the front end of any truck or large vehicle and provides a stable surface from which a user may stand to perform work on the vehicle. Furthermore, the vehicle-attachable work platform device can be folded into itself such that it can be easily transported and stored.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle-attachable work platform device primarily comprised of a body, at least one leg, and at least one arm. The device is designed to be secured to the front end of a truck or other large vehicle to provide a stable platform from which a mechanic or other user may work on various parts of the truck that lie under the hood of the vehicle.

The body of the device is preferably made from a metal material. The body is further comprised of a first platform half and a second platform half that is attached via at least one hinge of the body. The first platform half and the second platform half may fold into one another about the hinge and the angle between the two may be temporarily fixed by activating a locking mechanism of the body.

The first platform half may be further comprised of a top surface that provides additional grip and stability to a user standing on the first platform half and at least one opening. The opening allows a fastener to secure an arm to the underside of the first platform half by placing the fastener through the opening. The second platform half is identical to the first platform half such that the top surface provides additional grip to a user and an arm may be fastened to the underside of the second platform half by placing a fastener through an opening of the second platform half.

The arm may be further comprised of a fastener, preferably a hook, that allows the device to attach to the front end of a vehicle. In addition, each platform half may be comprised of at least one leg that is attached via at least one hinge. In one potential embodiment, the leg may be telescoping, allowing the device to accommodate vehicles of varying height and uneven ground surfaces.

The present invention is also comprised of a method of using the device. First, a device is provided primarily comprised of a body, at least one leg, and at least one arm. Then, the hinge of the body may be secured via the locking mechanism such that the first platform half and the second platform half are level. Then, the arms may be passed through an opening of the body and set to a desired width apart from one another. Next, each arm may be secured to the first platform half and the second platform half by placing a fastener through the opening of each platform half and into the arm. Then, the fastener of the arm may be secured to the frame or other part of a truck. Then, each leg may be adjusted to a desired height and fixed at that height via the locking member. Finally, a user may stand on the first platform half, the second platform half, or both to complete any necessary repairs on the vehicle to which the device is attached.

The present invention is also comprised of a second method of using the device. First, a device is provided primarily comprised of a body, at least one leg, and at least one arm. Then, the hinge of the body may be secured via the locking mechanism such that the first platform half and the second platform half are level. Then, the arms may be passed through an opening of the body and set to a desired width apart from one another. Next, each arm may be secured to the first platform half and the second platform half by placing a fastener through the opening of each platform half and into the arm. Then, the fastener of the arm may be secured to the frame or other part of a truck. Then, each leg may be adjusted to a desired height and fixed at that height via the locking member. Next, a user may stand on the first platform half, the second platform half, or both to complete any necessary repairs on the vehicle to which the device is attached. Then, each arm may be detached from the vehicle and each leg may be collapsed to the shortest length and folded into the body. Finally, the first platform half and the second platform half may be folded into one another to transport the device to storage.

Accordingly, the vehicle-attachable work platform device of the present invention is particularly advantageous as it provides a device that allows a user to easily access the front end of a truck or other raised vehicle to perform work on the vehicle. More specifically, the vehicle-attachable work platform device can be compacted by folding into itself, allowing for easier transportation and storage of the device. Furthermore, the vehicle-attachable work platform device can be secured to the front end of any large vehicle to provide a stable surface from which a mechanic may perform work on the engine or other parts of the vehicle. In this manner, the vehicle-attachable work platform device provides a solution while working on the engine bay of a vehicle such as, but not limited to, a truck.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle-attachable work platform device of the present invention while unfolded in accordance with the disclosed architecture;

FIG. 2 illustrates a perspective view of one potential embodiment of a vehicle-attachable work platform device of the present invention while partially folded in accordance with the disclosed architecture;

FIG. 3 illustrates a flowchart of a method of using one potential embodiment of a vehicle-attachable work platform device of the present invention in accordance with the disclosed architecture; and

FIG. 4 illustrates a flowchart of a method of using one potential embodiment of a vehicle-attachable work platform device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that provides an increase in elevation when performing work on the front end of a truck or other raised vehicle. More specifically, there exists a long-felt need in the art for a vehicle-attachable work platform device that attaches to the front end of a truck and provides a stable surface from which a mechanic may perform work. Furthermore, there exists a long-felt need in the art for a vehicle-attachable work platform device that can be easily stored and transported.

The present invention, in one exemplary embodiment, is comprised of a vehicle-attachable work platform device. The device is primarily comprised of a body, at least one leg, and at least one arm. The device is designed to be secured to the front end of a truck or other large vehicle to provide a stable platform from which a mechanic or other user may work on various parts of the truck that lie under the hood of the vehicle.

More specifically, the device is comprised of a body that may be made from any material but is preferably made from a metal material. The body is further comprised of a first platform half and a second platform half. The first platform half and the second platform half may be removably attached via at least one hinge of the body that allows the first platform half and the second platform half to fold into each other. A locking mechanism may provide stability to the body such that when the locking mechanism is activated, the first platform half and the second platform half are fixed and may not rotate about the hinge. A top surface of the first platform half and a top surface of the second platform half may be further comprised of a differing material or texture that provides additional grip and stability for the user standing on the body of the device.

At least one leg may be fixedly or removably attached to the body via at least one hinge. In the preferred embodiment, the first platform half and the second platform half are each comprised of a leg, adding stability from both sides of the device. In one potential embodiment, the leg may be of a fixed length. In another potential embodiment, the leg may be telescoping such that the length of the leg may change to accommodate vehicles of differing heights or uneven ground. The leg may be further comprised of a locking member that may temporarily fix the length of the telescoping leg at a length desired by the user.

The body may be further comprised of at least one opening. The opening of the body may allow at least one arm to be inserted underneath the unfolded body. The arm may be further comprised of at least one fastener that allows the arm to attach to the vehicle. The fastener may be any fastener known in the art but is preferably a hook. In the preferred embodiment of the device, one arm may be attached to the first platform half and another arm may be attached to the second platform half such that the device is comprised of two arms. The arm may be secured to the first platform half via at least one fastener. The fastener may be partially inserted through at least one opening of the first platform half and be secured to the arm. The opening of the first platform half may be large, allowing the arm to slide horizontally along the length of the first platform half to accommodate vehicles of differing sizes. In addition, the arm may be secured to the second platform half via at least one fastener. The second platform half may be symmetrical with the first platform half such that it is comprised of at least one opening from which the fastener may partially pass through to secure the arm to the second platform half.

The present invention is also comprised of a method of using the device. First, a device is provided primarily comprised of a body, at least one leg, and at least one arm. Then, the hinge of the body may be secured via the locking mechanism such that the first platform half and the second platform half are level. Then, the arms may be passed through an opening of the body and set to a desired width apart from one another. Next, each arm may be secured to the first platform half and the second platform half by placing a fastener through the opening of each platform half and into the arm. Then, the fastener of the arm may be secured to the frame or other part of a truck. Then, each leg may be adjusted to a desired height and fixed at that height via the locking member. Finally, a user may stand on the first platform half, the second platform half, or both to complete any necessary repairs on the vehicle to which the device is attached.

The present invention is also comprised of a second method of using the device. First, a device is provided primarily comprised of a body, at least one leg, and at least one arm. Then, the hinge of the body may be secured via the locking mechanism such that the first platform half and the second platform half are level. Then, the arms may be passed through an opening of the body and set to a desired width apart from one another. Next, each arm may be secured to the first platform half and the second platform half by placing a fastener through the opening of each platform half and into the arm. Then, the fastener of the arm may be secured to the frame or other part of a truck. Then, each leg may be adjusted to a desired height and fixed at that height via the locking member. Next, a user may stand on the first platform half, the second platform half, or both to complete any necessary repairs on the vehicle to which the device is attached. Then, each arm may be detached from the vehicle and each leg may be collapsed to the shortest length and folded into the body. Finally, the first platform half and the second platform half may be folded into one another to transport the device to storage.

Accordingly, the vehicle-attachable work platform device of the present invention is particularly advantageous as it provides a device that allows a user to easily access the front end of a truck or other raised vehicle to perform work on the vehicle. More specifically, the vehicle-attachable work platform device allows a mechanic or other user to safely perform work on the engine bay of a vehicle by attaching directly to the front end of the vehicle. Furthermore, the vehicle-attachable work platform device can fold together to allow for case of storage and transportation of the device. In this manner, the vehicle-attachable work platform device provides a solution while working on the engine bay of a vehicle such as, but not limited to, a truck.

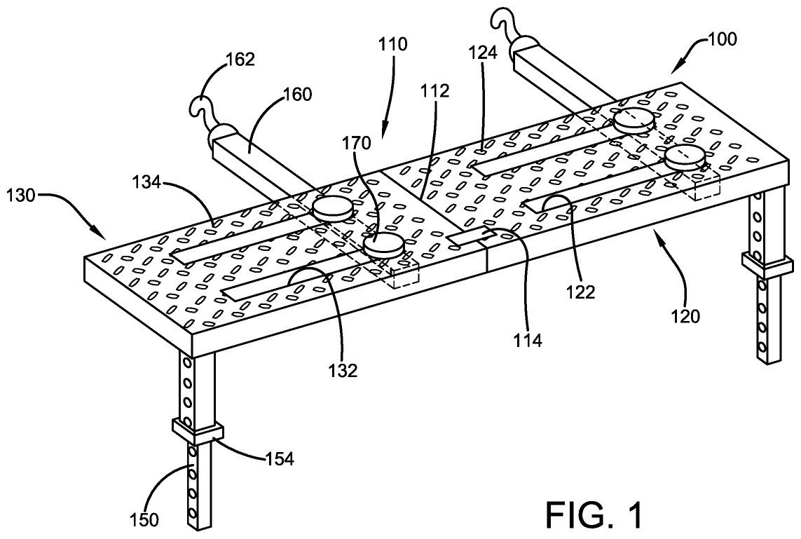

Referring initially to the drawings, FIG. 1 illustrates a perspective view of one potential embodiment of a vehicle-attachable work platform device 100 of the present invention while unfolded in accordance with the disclosed architecture. The device 100 is primarily comprised of a body 110, at least one leg 150, and at least one arm 160. The device 100 is designed to be secured to the front end (i.e., frame and/or bumper) of a truck or other large vehicle to provide a stable platform from which a mechanic or other user may stand on to work on the engine of the truck (or other raised areas)

The body 110 of the device 100 may be made from any material but is preferably made from a lightweight metal material such as aluminum or steel. The body 110 is further comprised of a first platform half 120 and a second platform half 130. The first platform half 120 and the second platform half 130 may be fixedly or removably attached to each other via at least one hinge 112. The hinge 112 allows the body 110 to be folded in half when not in use for storage. At least one locking mechanism 114 may temporarily lock the position of the first platform half 120 and the second platform half 130 such that they may not rotate about the hinge 112 when being used and/or stored. The locking mechanism 114, in one potential embodiment, may automatically operate at end ranges of motion, such as when the first platform half 120 and the second platform half 130 are coincident in the same plane or folded into one another. The locking mechanism 114, in another potential embodiment, may be activated manually at any angle of rotation in which the first platform half 120 or the second platform half 130 is rotated about the hinge 112.

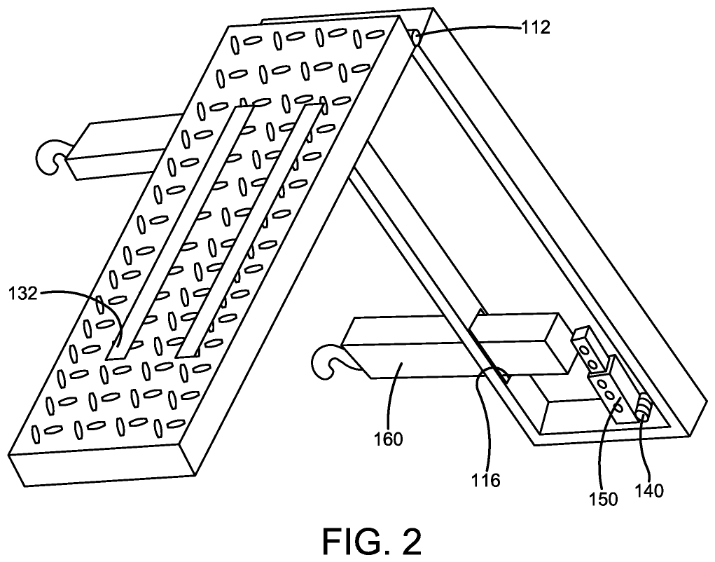

The first platform half 120 may be further comprised of at least one opening 122 and a top surface 124. The top surface 124 of the first platform 120 may be made from a differing material or be textured such that a user may be provided additional stability or grip when standing on the first platform half 120. In the preferred embodiment of the device 100, the first platform half 120 is comprised of two openings 122 but may be comprised of a single opening 122 or a plurality of openings 122 in differing embodiments. At least one arm 160 may be fixedly or removably attached to the first platform half 120 via at least one fastener 170 for each opening 122 of the first platform half 120. The arm 160 may pass through at least one opening 116 of the body 110, as best seen in FIG. 2, to be secured to the underside of the first platform half 120. The opening 116 of the body 110 and the opening 122 of the first platform half 120 may be sized to allow the arm 160 to be placed in various positions along the length of the first platform half 120.

The second platform half 130 may be further comprised of at least one opening 132 and a top surface 134. The top surface 134 of the second platform 130 may be made from a differing material or be textured such that a user may be provided additional stability or grip when standing on the second platform half 130. In the preferred embodiment of the device 100, the second platform half 130 is comprised of two openings 132 but may be comprised of a single opening 132 or a plurality of openings 132 in differing embodiments. At least one arm 160 may be fixedly or removably attached to the second platform half 130 via at least one fastener 170 for each opening 132 of the second platform half 130. The arm 160 may pass through at least one opening 116 of the body 110, as best seen in FIG. 2, to be secured to the underside of the second platform half 130. The opening 116 of the body 110 and the opening 132 of the second platform half 130 may be sized such that the arm 160 may be placed in various positions along the length of the second platform half 130. In this manner, the arms 160 of both halves 120, 130 can be repositioned depending on the width of the truck or vehicle the device 100 attaches to. The device 100 may be removably attached to a vehicle via at least one fastener 162 of the arm 160. The fastener 162 may be any fastener known in the art such as, but not limited to, a hook, a clamp, a clip, a suction cup, a magnet, etc.

At least one leg 150 may be fixedly or removably attached to the body 110 via at least one hinge 140 that allows the leg 150 to fold into the body 110. In the preferred embodiment of the device 100, each platform body 110 half 120, 130 is comprised of at least one leg 150 to provide support for the device 100 as well as the user standing on the device 100. The leg 150, in one potential embodiment, may be telescoping thereby allowing the leg 150 to increase or decrease in height as desired by the user. The length of the leg 150 may be temporarily fixed by activating a locking member 154 (of any type known in the art such as, but not limited to, a clip, a spring-loaded pin, etc.) of the leg 150. By telescoping, the leg 150 may accommodate differing vehicles in which the hood of the vehicles are at differing heights.

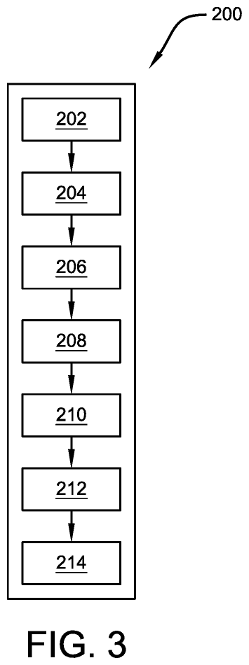

The present invention is also comprised of a method 200 of using the device 100, as seen in FIG. 3. First, a device 100 is provided primarily comprised of a body 110, at least one leg 150, and at least one arm 160 [Step 202]. Then, a hinge 112 of the body 110 may be secured via the locking mechanism 114 such that the first platform half 120 and the second platform half 130 are level [Step 204]. Next, the arms 160 may be passed through at least one opening 116 of both or cither half 120, 130 of the body 110 and set to a desired width apart from one another [Step 206]. Then, each arm 160 may be secured to the first platform half 120 and/or the second platform half 130 by placing a fastener 170 through the opening 122, 132 of each platform half 120, 130, and into each instance of the arm 160 [Step 208]. Then, the fastener 162 of the arm 160 may be secured to the frame or other part of a truck or other vehicle [Step 210]. Next, each leg 150 may be adjusted to a desired height and fixed at that height via the locking member 154 [Step 212]. Finally, a user may stand on the first platform half 120, the second platform half 130, or both to complete any necessary repairs on the vehicle to which the device 100 is attached [Step 214].

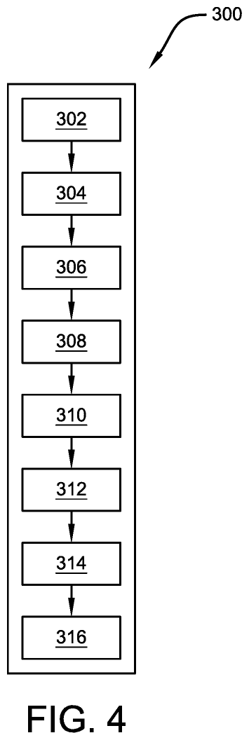

The present invention is also comprised of a second method 300 of using the device 100, as seen in FIG. 4. First, a device 100 is provided primarily comprised of a body 110, at least one leg 150, and at least one arm 160 [Step 302]. Then, a hinge 112 of the body 110 may be secured via the locking mechanism 114 such that the first platform half 120 and the second platform half 130 are level [Step 304]. Next, the arms 160 may be passed through at least one opening 116 of both or either half 120, 130 of the body 110 and set to a desired width apart from one another [Step 306]. Then, each arm 160 may be secured to the first platform half 120 and/or the second platform half 130 by placing a fastener 170 through the opening 122, 132 of each platform half 120, 130 and into each instance of the arm 160 [Step 308]. Then, the fastener 162 of the arm 160 may be secured to the frame or other part of a truck or other vehicle [Step 310]. Next, each leg 150 may be adjusted to a desired height and fixed at that height via the locking member 154 [Step 312]. Finally, a user may stand on the first platform half 120, the second platform half 130, or both to complete any necessary repairs on the vehicle to which the device 100 is attached [Step 314]. Finally, when finished the fasteners 162 may be removed from the truck and the first platform half 120 and the second platform half 130 may be folded (along with the legs 150 of the device 100) into one another to transport the device 100 to storage [Step 316].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle-attachable work platform device” and “device” are interchangeable and refer to the vehicle-attachable work platform device 100 of the present invention.

Notwithstanding the foregoing, the vehicle-attachable work platform device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle-attachable work platform device 100 as shown in the FIGS. are for illustrative purposes only, and that many other sizes and shapes of the vehicle-attachable work platform device 100 are well within the scope of the present disclosure. Although the dimensions of the vehicle-attachable work platform device 100 are important design parameters for user convenience, the vehicle-attachable work platform device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle-attachable work platform device comprising:
a platform body comprised of a first opening and a second opening;
a leg; and
an arm comprised of a fastener.

2. The vehicle-attachable work platform device of claim 1, wherein the second opening is positioned on a top surface of the platform.

3. The vehicle-attachable work platform device of claim 2, wherein the top surface is comprised of a texture.

4. The vehicle-attachable work platform device of claim 1, wherein the fastener is comprised of a hook, a clamp, a clip, a suction cup, or a magnet.

5. The vehicle-attachable work platform device of claim 1, wherein the platform body is comprised of a first half and a second half, wherein the first half attaches to the second half.

6. A vehicle-attachable work platform device comprising:
a platform body comprised of a first half comprised of a first opening and a second opening, the first half attached to a second half comprised of a third opening and a fourth opening via a first hinge;
a leg; and
an arm comprised of a first fastener.

7. The vehicle-attachable work platform device of claim 6, wherein the first hinge is comprised of a first locking mechanism.

8. The vehicle-attachable work platform device of claim 6, wherein the first opening receives the arm.

9. The vehicle-attachable work platform device of claim 6, wherein the third opening receives the arm.

10. The vehicle-attachable work platform device of claim 6, wherein the first fastener is comprised of a hook, a clamp, a clip, a suction cup, or a magnet.

11. The vehicle-attachable work platform device of claim 6, wherein the leg is comprised of a second hinge.

12. The vehicle-attachable work platform device of claim 6, wherein the leg is comprised of a telescopic leg.

13. The vehicle-attachable work platform device of claim 12, wherein the leg is comprised of a locking member.

14. A method of using a vehicle-attachable work platform device, the method comprising the following steps:
providing a vehicle-attachable work platform device comprised of a platform body comprised of a leg and an arm comprised of a fastener;
securing the arm to the platform body;
securing the fastener of the arm to a vehicle; and
standing on the platform body to perform vehicle repairs.

15. The method of using a vehicle-attachable work platform device of claim 14, wherein the arm attaches to the platform body.

16. The method of using a vehicle-attachable work platform device of claim 14, wherein the fastener is comprised of a hook, a clamp, a clip, a suction cup, or a magnet.

17. The method of using a vehicle-attachable work platform device of claim 14, wherein the platform body is comprised of a first half and a second half.

18. The method of using a vehicle-attachable work platform device of claim 17, wherein the first half attaches to the second half via a hinge.

19. The method of using a vehicle-attachable work platform device of claim 14, wherein the fastener is secured to a frame of the vehicle.

20. The method of using a vehicle-attachable work platform device of claim 14, wherein the arm is repositionable along the platform body.
